(19) United States
(12) Patent Application Publication
(10) Pub. No.: US 2021/0127879 A1
(43) Pub. Date: May 6, 2021

(54) TUFTED CARPET AND PRODUCTION METHOD THEREFOR

(71) Applicant: TOABO MATERIAL CO., LTD., Osaka (JP)

(72) Inventors: Kazuto HASHINO, Yokkaichi-shi (JP); Katsumasa MAKITA, Yokkaichi-shi (JP); Shigenori KOJIMA, Yokkaichi-shi (JP); Yutaka Shimamura, Yokkaichi-shi (JP)

(21) Appl. No.: 16/937,086

(22) Filed: Jul. 23, 2020

(30) Foreign Application Priority Data
Oct. 31, 2019 (JP) 2019-199378

(51) Int. Cl. A47G 27/02; D05C 17/02; B32B 5/26; B32B 3/10; B32B 5/02

(52) U.S. Cl. CPC A47G 27/02; D05C 17/026; B32B 2307/7145; B32B 3/10; B32B 5/024; B32B 5/26

(57) ABSTRACT

A tufted carpet constructed by embedding pile yarns on a primary base fabric, where a ratio at which a surface of the primary base fabric is visible accounts for 5% to 85% as viewed from above the tufted carpet. The primary base fabric is formed by entangling a color fiber, a characteristic fiber, and a low melt fiber on a spunbonded base fabric or a woven base fabric. The color fiber imparts an appearance design to the surface of the primary base fabric; the characteristic fiber has at least one function selected from the group consisting of deodorization, antibacterial, anti-allergen, and anti-mite; and the low melt fiber melts at a lower temperature than melting points of the other color fiber and characteristic fiber, and fixes these fibers on the surface of the primary base fabric by thermocompression-bonding. The resulting carpet exhibits excellent shape stability, economical efficiency, and lightness.

### TECHNICAL FIELD OF THE INVENTION

The present invention relates to a tufted carpet that can express an unconventional, novel design and that is excellent in functionality, economical efficiency, and shape stability. The present invention also relates to a production method therefor.

### TECHNOLOGY BACKGROUND

Carpets are generally widely used as indoor floor coverings in buildings. Carpets can absorb sound or impact of walking or falling objects due to softness of surfaces, and can improve heat retention as a heat insulating material. Also, carpets can enhance designability and functionality depending on a fiber material used. Accordingly, carpets are the most important item as interior goods of buildings.

Carpets are classified into various types in accordance with their production methods. Particularly, tufted carpets are most popularly used because of their high productivity. Tufted carpets are constructed by densely embedding pile yarns such as wool, nylon, polyester, and polypropylene with multiple sewing needles on a primary base fabric (spunbonded nonwoven base fabric or woven fabric made of polyester or polypropylene). An appearance design of tufted carpets is not based on the primary base fabric, but based on a yarn structure of the pile that is visually recognized mainly from the outside.

Many tufted carpets have been proposed which can be produced at low cost and have improved characteristics such as shape stability and functionality (for example, see Patent Documents 1 and 2). However, at present, no proposal has been made for a tufted carpet capable of expressing an unconventional, novel design by using elements other than pile yarns.

### PRIOR TECHNICAL DOCUMENTS

### Patent Documents

Patent Document 1: Japanese Utility Model Application Laid-Open No. 6293/95

Patent Document 2: Japanese Patent Application Laid-Open (JP-A) No. 2014-233480

### DISCLOSURE OF THE INVENTION

### Problem that the Invention is to Solve

The present invention has been made in view of the above situation of the conventional technology. An object of the present invention is to provide a tufted carpet capable of expressing an unconventional, novel design and imparting high functionality, and excellent in shape stability, economical efficiency, and lightness, as well as a production method therefor.

### Means for Solving the Problem

As a result of diligent study to achieve the above object, firstly, in order to express an unconventional, novel design, the inventors thought up exposing a surface of the primary base fabric which has been conventionally completely covered with pile yarns, in a specific ratio as a design element. Then, in order to enhance designability of the exposed part of the primary base fabric and further impart functionality, the inventors have found out that it is possible to impart not only excellent designability but also excellent functionality and shape stability by thermocompression-bonding a color fiber that can impart a specific novel design and a characteristic fiber that can impart a specific function to the surface of the primary base fabric with a fiber having a lower melting point than the other color fiber and characteristic fiber.

The present invention has been completed on the bases of these findings and has the following configurations (1) to (4).

(1) A tufted carpet constructed by embedding pile yarns on a primary base fabric, wherein a ratio at which a surface of the primary base fabric is visible accounts for 5% to 85% as viewed from above the tufted carpet, wherein the primary base fabric is formed by entangling a color fiber, a characteristic fiber, and a low melt fiber on a spunbonded base fabric or a woven base fabric, wherein the color fiber is for imparting an appearance design to the surface of the primary base fabric, wherein the characteristic fiber has at least one function selected from the group consisting of deodorization, antibacterial, anti-allergen, and anti-mite, and wherein the low melt fiber melts at a lower temperature than melting points of the other color fiber and characteristic fiber.

(2) The tufted carpet according to (1), wherein the color fiber imparts the appearance design to the surface of the primary base fabric by at least one design element selected from the group consisting of fineness, length, presence or absence of crimps, cross-sectional shape, and color of yarns constituting the fiber.

(3) The tufted carpet according to (1) or (2), wherein the low melt fiber comprises polyolefin fibers or low melting point binder polyester fibers of core-sheath type or all melt type.

(4) A method for producing the tufted carpet according to any one of (1) to (3), wherein the method comprises the steps of: layering the color fiber, the characteristic fiber, and the low melt fiber on the spunbonded base fabric or the woven base fabric; punching the layered fibers with a needle to entangle the fibers; thermocompression-bonding the entangled fibers to form the primary base fabric; and then embedding the pile yarns on only a part of the surface of the primary base fabric so that remaining part of the surface of the primary base fabric is visible from above.

### Advantages of the Invention

The tufted carpet of the present invention, which is configured such that the surface of the primary base fabric is exposed at a specific ratio, can express an unconventional, novel design with design configurations of both the pile yarns present on the surface and the exposed surface of the primary base fabric.

Further, in the tufted carpet of the present invention, an amount of the pile yarns used is reduced due to the exposure of the primary base fabric. Accordingly, costs can reduced by reducing the amount of the pile yarns, and a weight of the product can be reduced by reducing the amount of the pile yarns on the surface.

Furthermore, in the tufted carpet of the present invention, the color fiber having a high design effect and the characteristic fiber capable of imparting a specific function are arranged on the surface of the exposed primary base fabric. Accordingly, high designability can be imparted. In addition, a functional effect of the characteristic fiber can be effectively exhibited without being blocked by tuft yarns. Further, the color fiber and the characteristic fiber are thermocompression-bonded to the surface of the primary base fabric with the low melt fiber having a lower melting point than the other color fiber and characteristic fiber. Accordingly, the color fiber and the characteristic fiber are sufficiently fixed to the primary base fabric and do not fall out. Thus, a high shape stability of the primary base fabric can be maintained.

### BRIEF DESCRIPTION OF THE DRAWINGS

FIG. 1 is a schematic sectional view of one example of a tufted carpet of the present invention.

FIG. 2A is a schematic perspective view and FIG. 2B is a photograph of a surface of one example of the tufted carpet of the present invention.

FIGS. 3A and 3B are explanatory diagrams of a method of calculating a ratio at which a surface of a primary base fabric of the tufted carpet of the present invention is visible, with an exposure ratio of 25% in FIG. 3A and 59% in FIG. 3B.

FIG. 4A is a schematic sectional view and FIG. 4B is a photograph of a backside of a conventional tufted carpet.

FIG. 5A is a schematic sectional view and FIG. 5B is a photograph of a backside of the tufted carpet of the present invention.

FIG. 6 is photographs of a surface of a tufted carpet produced in Example 1.

FIG. 7 is photographs of a surface of a tufted carpet produced in Example 2.

FIG. 8 is a photograph of a surface of a tufted carpet produced in Comparative Example 1.

FIG. 9 is a photograph of a surface of a tufted carpet produced in Comparative Example 2.

### BEST MODE FOR CARRYING OUT THE INVENTION

An embodiment of the tufted carpet of the present invention will be described below with reference to the drawings, but the present invention is not limited thereto.

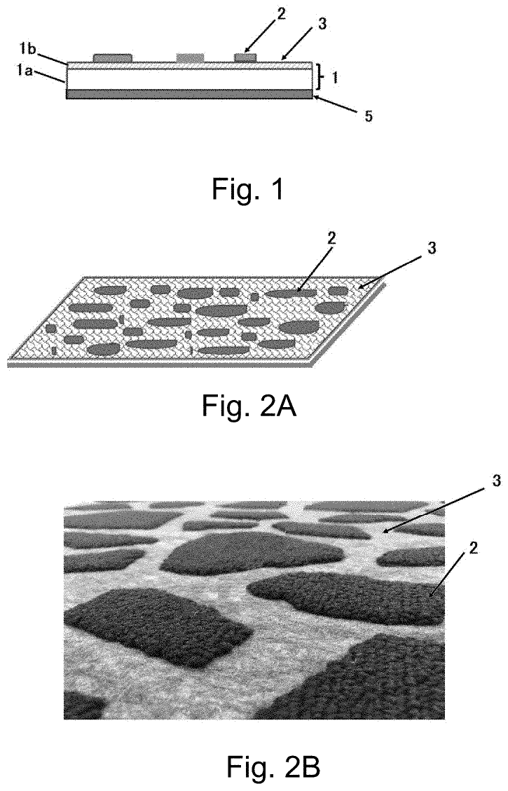

In a tufted carpet of the present invention, as shown in a sectional view of FIG. 1, basically similarly to a conventional tufted carpet, pile yarns are embedded on a primary base fabric 1, and a secondary base fabric 5 is placed on a backside of the primary base fabric 1 as necessary. As viewed from above the tufted carpet, not only a part 2 covered with the pile yarns but also a part 3 wherein a surface of the primary base fabric 1 provided with designability is exposed can be visually clearly recognized at a specific ratio, which is unconventional characteristics. A surface of the conventional tufted carpet is densely covered with pile yarns, and only the pile yarns are virtually visible as viewed from above. Accordingly, the designability of the conventional tufted carpets is determined solely by a configuration and a dyed color of the pile yarns. On the other hand, as shown in FIGS. 2A and 2B, an entire design of the tufted carpet of the present invention as viewed from above is determined by a design configured by a combination of the part 2 covered with the pile yarns and the exposed surface 3 of the primary base fabric provided with designability. Consequently, an unconventional, novel, and unusual design can be expressed according to the tufted carpet of the present invention.

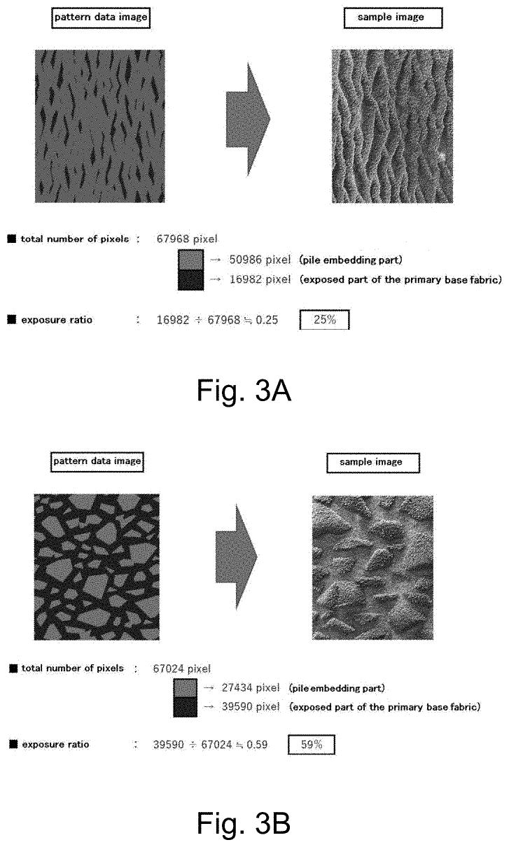

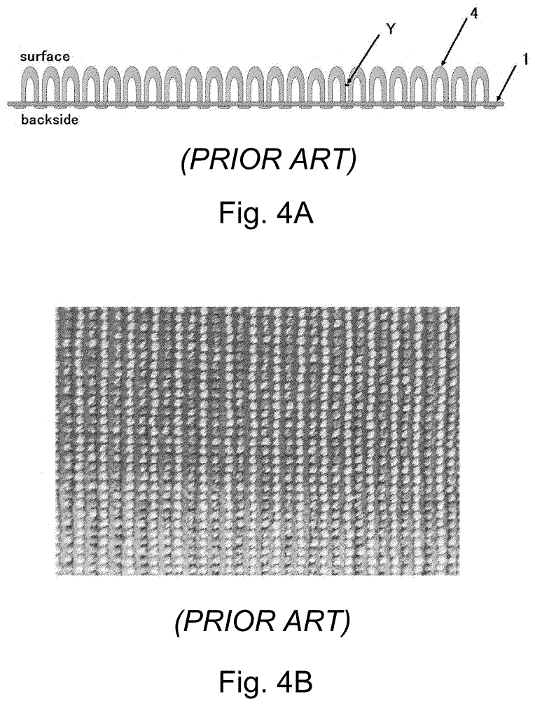

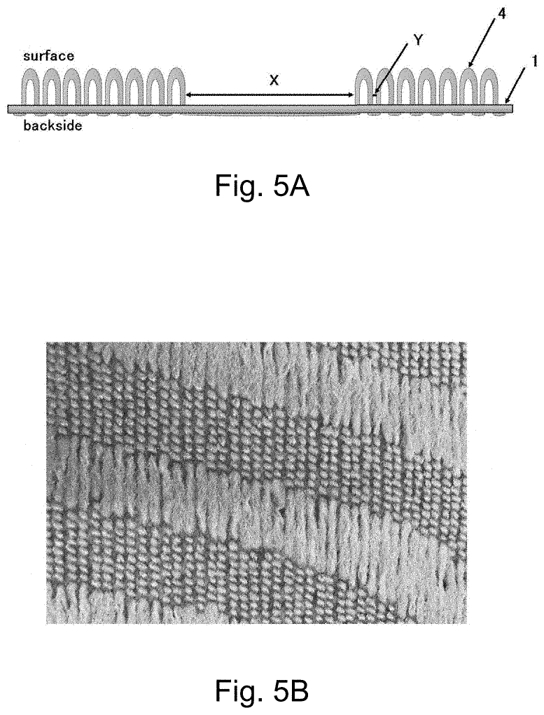

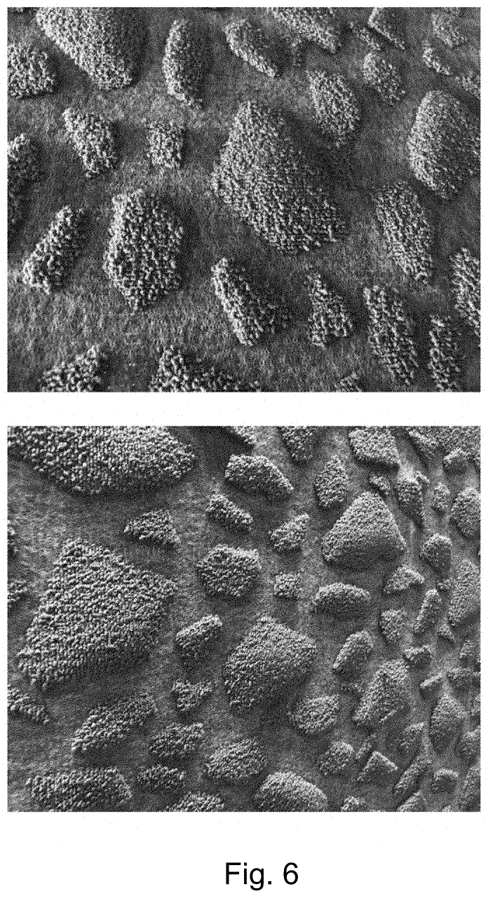

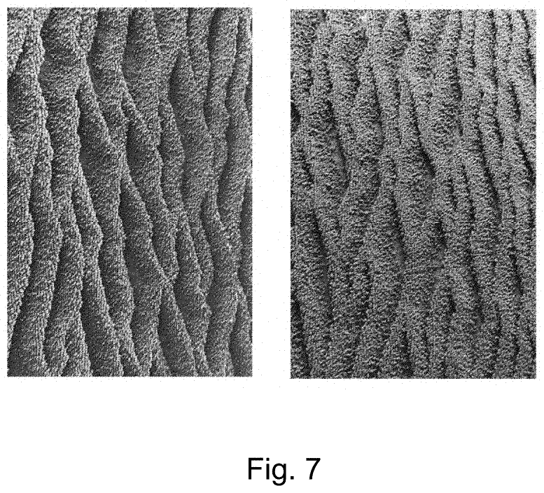

The tufted carpet of the present invention is formed such that a ratio at which the surface of the primary base fabric is visible as viewed from above accounts for 5% to 85%, preferably 10% to 80%. BMP data are used to determine a pattern for tufting the pile yarns on the tufted carpet. The ratio (%) at which the surface of the primary base fabric is visible is determined by dividing a number of pixels in the exposed part of the primary base fabric on the basis of the BMP data by a total number of pixels of the entire primary base fabric (number of pixels in a pile embedding part+number of pixels in the exposed part of the primary base fabric). The ratio is expressed by percentage. For reference, FIGS. 3A and 3B show calculation examples of the ratio (exposure ratio) (%) at which the surface of the primary base fabric in the tufted carpet is visible. In the tufted carpet of the present invention, the part wherein the surface of the primary base fabric is visible preferably has a space between adjacent embedded pile yarns (such as X in FIG. 5A) which is longer than a normal space (Y in FIG. 4A and Y in FIG. 5A), and equal to or longer than 0.3 inches, more preferably equal to or longer than 0.5 inches, in some parts. When the ratio at which the surface of the primary base fabric is visible as viewed from above is less than the above ratio, the surface of the primary base fabric provided with designability is almost invisible. Accordingly, the tufted carpet is not greatly different from the conventional design that relies only on the design of pile yarns. On the other hand, when the ratio is more than the above ratio, the exposed surface of the primary base fabric provided with designability becomes too conspicuous for the designability of the pile yarns to be sufficiently utilized, which is unfavorable. In the tufted carpet of the present invention, a three-dimensional sea-island structure design is shown in which the part wherein the surface of the primary base fabric is visible configures a sea, and the part wherein the pile yarns are embedded configures an island as viewed from above. For example, when the ratio at which the surface of the primary base fabric is visible is small, a design feature can be imparted to the shape of the part wherein the pile yarns are missing, as shown in FIG. 7. When the ratio at which the surface of the primary base fabric is visible is large, a design feature can be imparted to a contrast of the sea-island structure and the design provided on the surface of the primary base fabric as shown in FIG. 6. Regarding the pile yarns, conventionally known yarns comprising wool, nylon, polyester, polypropylene, and the like can be used. And such like pile yarns are an important design component in addition to the exposed surface of the primary base fabric.

The primary base fabric 1 used in the tufted carpet of the present invention, as shown in FIG. 1, is formed by entangling a fiber 1b comprising a color fiber, a characteristic fiber, and a low melt fiber with above a spunbonded base fabric or a woven base fabric 1a. Regarding the spunbonded base fabric, conventionally known fabrics can be used. For example, there are fabrics produced from polyester, polypropylene, or a mixed material of polyester and polypropylene by thermocompression-bonding or needle-punching. Regarding the woven base fabric, similarly, a conventionally known fabric can be used. For example, there is a plain woven or twill woven fabric using a polypropylene or polyester material. In the tufted carpet of the present invention, the primary base fabric not only holds the pile yarns but also imparts designability and functionality as important characteristics. The tufted carpet of the present invention is significantly different from the conventional tufted carpet in which the primary base fabric is used as a part only for holding the pile yarns.

The color fiber used in the present invention imparts an appearance design to the surface of the primary base fabric. Specifically, the fiber preferably imparts it by at least one design element selected from the group consisting fineness, length, presence or absence of crimps, cross-sectional shape, and color of fiber. The fiber may be selected from among conventionally known fibers having designability. Examples of the color fiber should be selected from the materials such as polypropylene, polyester, nylon, rayon, and acrylic, having a fineness of 0.5 dtex to 300 dtex, a length of 38 mm to 89 mm, a crimped shape, a round cross-section, a flat cross-section, or an irregular cross-section, a white or colored gloss of dull to bright, but are not limited thereto. Any amount of the color fiber used is sufficient as long as a desired appearance design can be imparted to the surface of the primary base fabric.

The characteristic fiber used in the present invention imparts functionality to the primary base fabric. Specifically, it has at least one function selected from the group consisting of deodorization, antibacterial, antiallergen, and anti-mite. The deodorization function is, for example, a function of decomposing or suppressing the odor of malodorous substances such as ammonia, hydrogen sulfide, acetic acid, methyl mercaptan, and isovaleric acid. The antibacterial function is a function of suppressing a growth of various bacteria such as Staphylococcus aureus, Escherichia coli, Klebsiella pneumoniae, and Pseudomonas aeruginosa in, for example, the quantitative test (bacterial fluid absorption method) according to JIS L1902. The anti-allergen function is a function of adsorbing, for example, house dust, pollen, food allergens, and the like, and mitigating and reducing allergic symptoms thereby caused. The anti-mite function is a function of adsorbing, for example, carcasses of mites and feces of mites and mitigating and reducing allergic symptoms thereby caused. Regarding a method for imparting these functions to fibers to prepare the above characteristic fiber, a conventionally known method may be adopted and thus will not be described in detail here. The characteristic fiber may also be used as the color fiber, as far as it is possible to impart an appearance design to the surface of the primary base fabric.

The low melt fiber used in the present invention melts at a lower temperature than the other color fiber and characteristic fiber. The low melt fiber may be selected from among conventionally known low melt fibers. Examples thereof include polyolefin fibers (polypropylene fibers, polyethylene fibers, and the like), or low melting point binder polyester fibers of core-sheath type or all melt type. The low melt fiber has a role to fix the color fiber and the characteristic fiber to the spunbonded base fabric or the woven base fabric by melting itself by heat, and contributes to preventing the color fiber and the characteristic fiber from falling off, and to the shape and dimension stability of the base fabric. Regarding a method for producing the low melt fiber, a conventionally known method may be adopted and thus will not be described in detail here.

Next, one example of the method for producing the tufted carpet of the present invention will be described. First, a base fabric such as polyester spunbonded base fabric or polypropylene woven base fabric is provided. Next, a required amount of a color fiber, a characteristic fiber, and a low melt fiber is layered onto this base fabric in web state of 80 g/m² to 100 g/m², and then a surface of the base fabric is punched with a needle to entangle the layered fibers. Subsequently, the surface of the base fabric is heat treated with a calender roller at, for example, 140° C. to 160° C. to melt the low melt fiber and thermocompression-bond the low melt fiber onto the surface of the base fabric with the color fiber and the characteristic fiber to complete the primary base fabric.

Further, pile yarns are embedded from above on the surface of the primary base fabric (tufting). At this time, the pile yarns are embedded on only a part of the surface of the primary base fabric so that remaining part of the surface of the primary base fabric is visible in an exposed state from above, in accordance with desired BMP pattern data. In the conventional tufted carpet, as shown in a sectional view of FIG. 4A and a photograph of a backside of FIG. 4B, the pile yarns are embedded at a uniform and dense pitch on the primary base fabric, and thus only the pile yarns are visually recognized as viewed from above. On the contrary, in the tufted carpet of the present invention, as shown in a sectional view of FIG. 5A and a photograph of a backside of FIG. 5B, the pile yarns are embedded at a coarser pitch than conventionally as in X part on the primary base fabric, and thus X part of the primary base fabric shown in FIGS. 5A and 5B is exposed on the surface. A combination of this exposed part of the primary base fabric and the part wherein the pile yarns are embedded at a dense pitch can create an unconventional, novel design. The exposed part of the primary base fabric is not limited to the conventional role of the primary base fabric of holding the pile yarns, but can impart high designability by the color fiber which has been pressure-bonded to the surface of the primary base fabric. If necessary, a secondary base fabric can be attached to the backside of the primary base fabric by a method similar to the conventional method, or the backside can be coated with a resin, sol, or gel.

The tufted carpet of the present invention configured as described above can present an unconventional, novel design by a simple method with a combination of the exposed part of the primary base fabric provided with designability and the part on which the pile yarns are arranged. Further, the amount of pile yarns used is reduced due to the exposure of the primary base fabric, which makes it possible to achieve high economical efficiency and weight reduction, and also to enhance the effect of the characteristic fiber by exposing the characteristic fiber on the surface of the primary base fabric.

### EXAMPLES

Hereinafter, the effects of the tufted carpet of the present invention will be shown by examples, though the present invention is not limited thereto.

### Example 1

“MARIX 81006BSE” manufactured by Unitika Ltd. as a spunbonded nonwoven fabric made of polyester was provided. Then, (a) color fiber, (b) characteristic fiber, and (c) low melt fiber as shown below were layered in a web state of 90 g/m² on the nonwoven fabric and entangled by a needle punch.

| | | | | |
|---|---|---|---|---|
| | | | cross- | |
| trade | deci-tex × | Color | sectional | |
| name | length | number | shape | luster |

(a) Color fiber (mixture of equal quantity of three types of
polypropylene fiber manufactured in-house)

| | | | | |
|---|---|---|---|---|
| PP-CL | 17.0 × 76 mm | F60R | round shape | semi-bright |
| PP-CL | 7.8 × 76 mm | 1617U | round shape | semi-bright |
| PP-BL | 17.0 × 76 mm | F20R | round shape | semi-bright |

(b) Characteristic fiber (mixture of equal quantity of two types
of “Phthalocyanine” manufactured by Daiwabo Neu Co.)
(having deodorization, antibacterial, antiallergen,
and anti-mite effects)

| | | | | |
|---|---|---|---|---|
| DW-RY-SS | 5.6 × 76 mm | BR1041 | flat shape | dull |
| DW-RY-D | 7.8 × 76 mm | BR1043 | flat shape | dull |

(c) Low melt fiber (polyester core-sheath fiber
manufactured by Unitika Ltd.)

| | | | | |
|---|---|---|---|---|
| UN-MPT | 4.4 × 51 mm | RW (R080) | round shape | semi-dull |
| | | | (core-sheath) | |

Next, only the low melt fiber was melted by compressing from above with a calender roller having a surface temperature of 150° C., and the fibers of (a), (b), and (c) were thermocompression-bonded to the nonwoven fabric to prepare a primary base fabric. Next, pile yarns comprising polyester were embedded in a design according to the BMP pattern data with the ratio at which the surface of the primary base fabric is visible of 59%. FIG. 6 shows a photograph of the surface of the finished tufted carpet.

As can be seen from FIG. 6, the tufted carpet of Example 1 has succeeded in improving designability by creating an unconventional, novel design. Further, it was possible to reduce costs and weight due to a reduction in the pile yarns, improve functions by exposing the characteristic fiber on the surface, as well as prevent the color fiber and the characteristic fiber from falling off and stabilize the shape and dimension by using the low melt fiber.

### Example 2

“RF24X18” manufactured by HAGIHARA INDUSTRIES INC. as a woven base fabric made of polypropylene was provided. Then, (a) color fiber, (b) characteristic fiber, and (c) low melt fiber as shown below were layered in a web state of 90 g/m² on the base fabric and entangled by a needle punch.

| | | | | |
|---|---|---|---|---|
| | | | cross- | |
| trade | deci-tex × | Color | sectional | |
| name | length | number | shape | luster |

(a) Color fiber (mixture of equal quantity of three types of
polypropylene fiber manufactured in-house)

| | | | | |
|---|---|---|---|---|
| PP-CL | 17.0 × 76 mm | F60R | round shape | semi-bright |
| PP-CL | 7.8 × 76 mm | 1617U | round shape | semi-bright |
| PP-BL | 17.0 × 76 mm | F20R | round shape | semi-bright |

(b) Characteristic fiber (mixture of equal quantity of two types
of “Phthalocyanine” manufactured by Daiwabo Neu Co.)
(having deodorization, antibacterial, antiallergen,
and anti-mite effects)

| | | | | |
|---|---|---|---|---|
| DW-RY-SS | 5.6 × 76 mm | BR1041 | flat shape | dull |
| DW-RY-D | 7.8 × 76 mm | BR1043 | flat shape | dull |

(c) Low melt fiber (polyester core-sheath fiber
manufactured by Unitika Ltd.)

| | | | | |
|---|---|---|---|---|
| UN-MPT | 4.4 × 51 mm | RW (R080) | round shape | semi-dull |
| | | | (core-sheath) | |

Next, only the low melt fiber was melted by compressing from above with a calender roller having a surface temperature of 150° C., and the fibers of (a), (b), and (c) were thermocompression-bonded to the nonwoven fabric to prepare a primary base fabric. Next, pile yarns comprising polyester were embedded in a design according to the BMP pattern data with the ratio at which the surface of the primary base fabric is visible of 25%. FIG. 7 shows a photograph of the surface of the finished tufted carpet.

As can be seen from FIG. 7, the tufted carpet of Example 2 has succeeded in improving designability by creating an unconventional, novel design. Further, it was possible to reduce costs and weight due to a reduction in the pile yarns, improve functions by exposing the characteristic fiber on the surface, as well as prevent the color fiber and the characteristic fiber from falling off and stabilize the shape and dimension by using the low melt fiber.

### Comparative Example 1

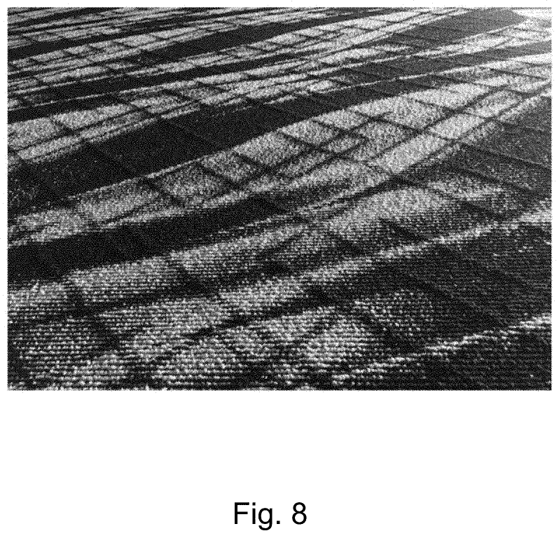

A primary base fabric was prepared by using the same material and production method as in Example 1. Then, pile yarns comprising polyester were embedded by a conventional method such that a ratio at which the surface of the primary base fabric is visible was 0%. FIG. 8 shows a photograph of the surface of the finished tufted carpet.

As can be seen from FIG. 8, the tufted carpet of Comparative Example 1 is in a conventional design category, and has not succeeded in creating a novel design. Further, compared with the tufted carpet of Example 1, there is no reduction in the pile yarns, which was disadvantageous in terms of cost reduction and weight reduction. Further, since the characteristic fiber was not exposed on the surface, levels of the functions such as deodorization and antibacterial were inferior to those achieved in Example 1.

### Comparative Example 2

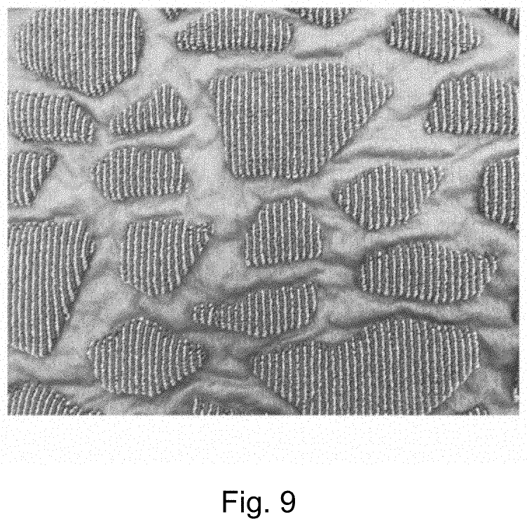

A primary base fabric was prepared similarly to Example 1 except that the color fiber, characteristic fiber, and low melt fiber were not used. Pile yarns comprising polyester were embedded in a design according to the BMP pattern data with the ratio at which the surface of the primary base fabric is visible of 59%. FIG. 9 shows a photograph of the surface of the finished tufted carpet.

As can be seen from FIG. 9, the tufted carpet of Comparative Example 2, which does not use the color fiber for the exposed surface of the primary base fabric, has not improved designability although the tufted carpet has an unconventional, novel design. Further, due to lack of the low melt fiber, the primary base fabric had wrinkles as shown in FIG. 9, and the shape and dimensions were unstable.

### INDUSTRIAL APPLICABILITY

The tufted carpet of the present invention can express an unconventional, novel design and impart high functionality, is excellent in shape stability, economical efficiency, and lightness. Accordingly, the tufted carpet of the present invention is significantly useful in the industry.

### EXPLANATION OF REFERENCE NUMBER

1: primary base fabric
2: part covered with the pile yarns
3: part wherein a surface of the primary base fabric is exposed
4: pile yarns
5: secondary base fabric
X: part wherein pile yarns are embedded with a coarse pitch space
Y: part wherein pile yarns are embedded with a normal pitch space

1. A tufted carpet constructed by embedding pile yarns on only a part of a surface of a primary base fabric, wherein a ratio at which a surface of the primary base fabric is visible accounts for 5% to 85% as viewed from above the tufted carpet, wherein the primary base fabric is formed by entangling a color fiber, a characteristic fiber, and a low melt fiber on a spunbonded base fabric or a woven base fabric, wherein the color fiber is for imparting an appearance design to the surface of the primary base fabric, wherein the characteristic fiber has at least one function selected from the group consisting of deodorization, antibacterial, anti-allergen, and anti-mite, and wherein the low melt fiber melts at a lower temperature than melting points of the other color fiber and characteristic fiber.

2. The tufted carpet according to claim 1, wherein the color fiber imparts the appearance design to the surface of the primary base fabric by at least one design element selected from the group consisting of fineness, length, presence or absence of crimps, cross-sectional shape, and color of yarns constituting the fiber.

3. The tufted carpet according to claim 1 or 2, wherein the low melt fiber comprises polyolefin fibers or low melting point binder polyester fibers of core-sheath type or all melt type.

4. A method for producing the tufted carpet according to claim 1 or 2, wherein the method comprises the steps of: layering the color fiber, the characteristic fiber, and the low melt fiber in a web state, on the spunbonded base fabric or the woven base fabric; punching the layered fibers with a needle to entangle the fibers; thermocompression-bonding the entangled fibers to form the primary base fabric; and then embedding the pile yarns on only a part of the surface of the primary base fabric so that remaining part of the surface of the primary base fabric is visible from above.
